(19) United States
(12) Patent Application Publication
(10) Pub. No.: US 2009/0038480 A1
(43) Pub. Date: Feb. 12, 2009

(54) AIR PURIFIER FOR REMOVING PARTICLES OR CONTAMINANTS FROM AIR

(75) Inventors: Michael Garman, Midlothian, VA (US); Mark Turner, Mechanicsville, VA (US); Guoyao Ye, Richmond, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH BRANDS, INC., Glen Allen, VA (US)

(21) Appl. No.: 12/188,274

(22) Filed: Aug. 8, 2008

Related U.S. Application Data
(60) Provisional application No. 60/955,052, filed on Aug. 10, 2007.
(60) Provisional application No. 61/036,262, filed on Mar. 13, 2008.

(51) Int. Cl. B01D 46/02

(52) U.S. Cl. 96/414; 55/378

(57) ABSTRACT

An air purifier that removes particles or contaminants from air includes a base having an air inlet, an air outlet and an air flow path therethrough. An impeller urges air into the air inlet, through the air flow path and out of the air outlet and a motor drives the impeller. The motor and impeller are supported within the base. A foldable air filter is in fluid communication with the air outlet and is removably mountable to an exterior surface of the base proximate the air outlet.

### CROSS-REFERENCE TO RELATED APPLICATIONS

The present application claims the benefit of both U.S. Provisional Patent Application No. 60/955,052, filed Aug. 10, 2007 and entitled “Air Purifier for Removing Particles or Contaminants from Air,” and U.S. Provisional Patent Application No. 61/036,262, filed Mar. 13, 2008 and entitled “Air Purifier for Removing Particles or Contaminants from Air.”

### BACKGROUND OF THE INVENTION

The present invention is directed to an air purifier for removing particles or contaminants from air. Preferably, the air purifier removes dust and/or other particles from a room, typically in a household environment. More particularly, the present invention is directed to an air purifier that includes an inflatable, foldable and/or collapsible air filter removably mountable to an exterior surface of a base of the air purifier for ease of shipment and storage and to an air purifier that has a visual indicator to show when the air filter is becoming old, clogged and/or dirty. Further, the present invention is directed to an air purifier that includes a frame mountable to and extending from a base of the air purifier and removably surrounding the inflatable, foldable and/or collapsible air filter.

As room air and the atmosphere in general have become contaminated, dusty or otherwise dirtied, the general population has become aware of discomfort and other disadvantages associated with contaminated air. Air purification and/or filtration devices of various shapes, sizes and capacities have become popular as a result of the increased awareness of household air quality and air quality in general. Various air purifiers or air filtration devices are available for home or industrial use. However, such conventional air purifiers are typically large, bulky and difficult to transport and/or store. As a result, such air purifiers are expensive to deliver to consumers or other users Further, it is often difficult for users or consumers of conventional air purifiers to determine when the air filter is old, worn out or dirty.

Therefore, it would be desirable to construct an air purifier that removes particles or contaminants, including dust, from air that is conveniently and easily stored or transported and visually indicates when the air filter is old, worn out or dirty. Specifically, it would be desirable to create an air purifier that has an inflatable, foldable and/or collapsible air filter mounted to an exterior surface of a base of the air purifier. Such a configuration would allow for ease of storage and shipment. Further, it would be desirable to create an air purifier that has a light emitting device on an exterior surface of the base, which is enclosed by the air filter when mounted to the base, such that the light emitting device illuminates a portion of the air filter when power is supplied to a motor and the light emitting device appears to lessen in light intensity when the air filter becomes clogged with dust, particles or other contaminants. Furthermore, it would be desirable to create an air purifier that has a frame mountable to and extending from the base to provide an esthetically pleasing air purifier and to support the inflatable, foldable and/or collapsible air filter in an expanded or operating position.

### SUMMARY OF THE INVENTION

Briefly stated, a preferred embodiment of the present invention is directed to an air purifier that removes particles or contaminants from air and includes a base having an air inlet, an air outlet and an air flow path therethrough. An impeller urges air into the air inlet, through the air flow path and out of the air outlet. A motor drives the impeller and the motor and impeller are supported within the base. A foldable air filter is in fluid communication with the air outlet and is removably mountable to an exterior surface of the base proximate the air outlet.

In another aspect, a preferred embodiment of the present application is directed to an air purifier that removes particles or contaminants from air and includes a base having an air inlet, an air outlet and an air flow path therethrough. The base encloses a motor for driving an impeller and includes at least one light emitting device on an exterior surface. An air filter is removably mountable to an exterior surface of the base and encloses the at least one light emitting device when the air filter is mounted to the base. The at least one light emitting device illuminates at least a portion of the air filter when the air filer is mounted to the base and provides a visual indication when the air filter is becoming clogged.

### BRIEF DESCRIPTION OF THE SEVERAL VIEWS OF THE DRAWINGS

The foregoing summary, as well as the following detailed description of preferred embodiments of the present invention, will be better understood when read in conjunction with the appended drawings. For the purpose of illustrating the invention described in the present application, there are shown in the drawings embodiments which are presently preferred. It should be understood, however, that the invention is not limited to the precise arrangements and instrumentalities shown. In the drawings:

FIG. 1 is a front left perspective view of a preferred embodiment of an air purifier of the present invention;

FIG. 2 is an enlarged front left perspective view of a base of the air purifier shown in FIG. 1, with an air filter removed for clarity;

FIG. 3 is a rear perspective view of the base of the air purifier shown in FIG. 2, with the air filter removed for clarity;

FIG. 4 is a front perspective view of the base and a bottom perspective view of a portion of the air filter of the air purifier shown in FIG. 1;

FIG. 5 is a perspective view of the air filter shown in FIG. 1 in a folded position;

FIG. 6 is a perspective view of the air filter shown in FIG. 1 in a partially folded position;

FIG. 7 is a perspective view of the air filter shown in FIG. 1 in another partially folded position;

FIG. 8 is a perspective view of the air filter shown in FIG. 1 in a partially expanded position;

FIG. 9 is a perspective view of the air filter shown in FIG. 1 in a fully expanded or operating position;

FIG. 10 is a front right perspective view of a second preferred embodiment of an air purifier of the present invention;

FIG. 11 is a front right perspective view of the air purifier shown in FIG. 10, showing another version of a base for the air purifier;

FIG. 12 is a top perspective view of the air purifier shown in FIG. 10;

FIG. 13 is an enlarged exploded front left perspective view a portion of the air purifier shown in FIG. 10, with a fan and motor removed for clarity; and

FIG. 14 is an exploded view of the air purifier shown in FIG. 10, with a cover of a frame removed for clarity.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the air purifier and designated parts thereof. The terminology includes the above-listed words, derivatives thereof and words of similar import.

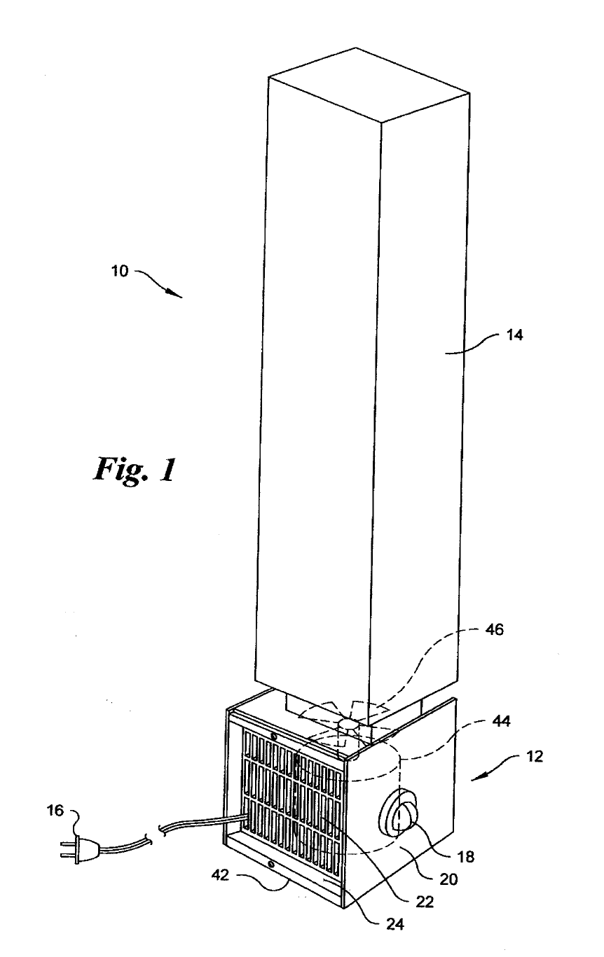

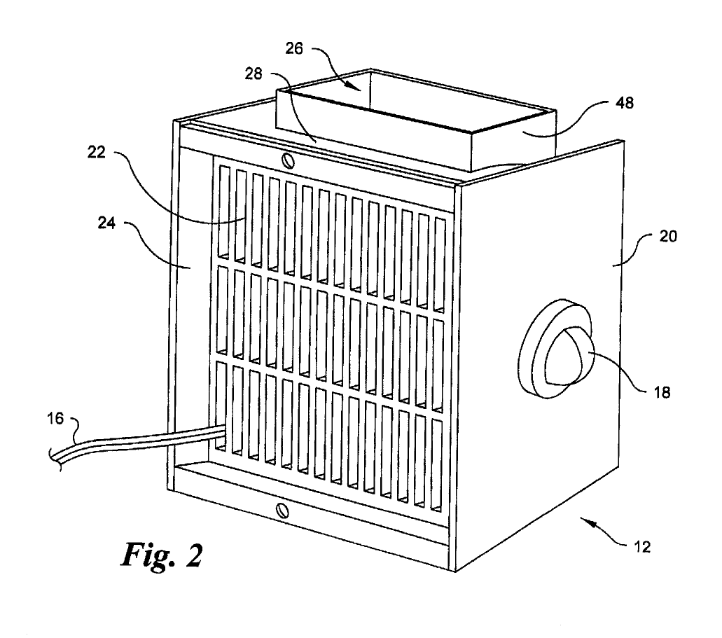

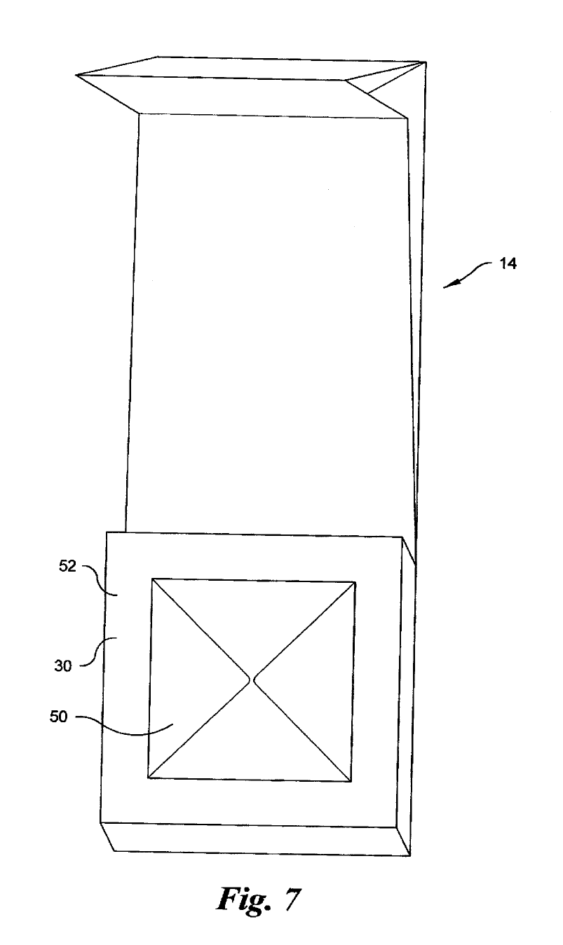

Referring to the drawings in detail, wherein like numerals indicate like elements throughout, there is shown in FIGS. 1-9 a first preferred embodiment of an air purifier, generally designated 10, for removing particles or contaminants from air. The structure of the air purifier 10 provides for ease of shipment and storage and provides a visual indication to a user when an air filter 14 of the air purifier 10 becomes old or clogged with dust, particles or other contaminants. Specifically, the air purifier 10 of the present invention includes a foldable, inflatable and/or collapsible air filter 14 that is removably mounted to an exterior portion of a base or housing 12 and at least one, but preferably two, spaced apart light emitting devices 34 located on an exterior surface, in the present embodiment a top surface 28, of the base 12 to provide a visual indication to the user when the air filter 14 becomes old, clogged or dirty.

Referring to FIGS. 1-4, the air purifier 10 includes the base 12 having a front surface 20, a rear surface 36, a left side surface 24, a right side surface 40, a top surface 28, and a bottom surface 42. Further, the base 12 includes an air inlet 22 on the left side surface 24, an air outlet 26 on the top surface 28 and an airflow path therethrough. It is understood by those skilled in the art that the shape of the air inlet 22 and air outlet 26 can be in virtually any form, such as circular or triangular, without departing from the spirit and scope of the invention. A motor 44 is positioned within the base 12 for driving an impeller or fan 46. Both the motor 44 and the impeller 46 are supported within and/or enclosed by the base 12. The impeller 46 is operatively connected to the motor 44 for urging air into the air inlet 22, through the airflow path and out of the base 12 through the air outlet 26.

In the first preferred embodiment, the motor 44 is comprised of an electric motor. However, the air purifier 10 is not limited to inclusion of an electric motor 44 and may include a battery operated motor or other type of motor or drive mechanism that is able to provide power to the impeller 46 to draw air into the air inlet 22, through the airflow path and out of the air outlet 26 of the base. In the first preferred embodiment, the impeller or fan 46 may be comprised of, but is not limited to, an axial-type fan or a “squirrel cage” type fan. Further, the fan 46 may be comprised of a basket-like fan, which is described in U.S. Pat. No. 6,328,791, which is incorporated herein by reference, or virtually any other type of fan configuration. Basket-like fans are generally well-known to those having ordinary skill in the art and will not be described in further detail herein.

In the first preferred embodiment, the base 12 is constructed of a molded, generally rigid polymeric material that is generally hollow between the air inlet 22 and the air outlet 26 to form the airflow path therethrough. However, the base 12 is not limited to being constructed of a generally rigid, molded polymeric material and may be constructed of nearly any material that is able to take on the general shape of the base 12 and withstanding normal operating conditions of the base 12. For example, the base 12 may be constructed of a form sheet metal, assembled wooden or machined metal or any other suitable material. In the first preferred embodiment, the base 12 is generally box-like in shape with generally square sides to provide a compact and stable support for the air purifier 10 and to provide convenient storage and shipment of the air purifier 10. However, it is understood by those skilled in the art that the form and shape of the base 12 can be modified without departing from the spirit and scope of the invention. For example, the sides of the base 12 can be rectangular, triangular or virtually any other shape without departing from the spirit and scope of the invention.

In the first preferred embodiment, the air inlet 22 and the air outlet 26 are comprised of slotted vents integrally molded into the base 12. This construction of the air inlet 22 and the air outlet 26 permits airflow through the air inlet 22 and air outlet 26 and generally prevents insertion of objects or appendages of a user's body into the air inlet 22 or air outlet 26 potentially into contact with moving parts of the air purifier 10 within the base 12. The air purifier 10 is not limited to integrally molded vents to form the air inlet 22 or air outlet 26. The air inlet 22 and the air outlet 26 may be comprised of nearly any penetration, hole, louvered vent or air permeable surface on the base 12 that permits airflow into and out of the base 12. For example, the air inlet 22 or the air outlet 26 may be comprised of a hole in the base 12, the hole being covered by an air permeable sheet or a plurality of holes in the base 12 that permit flow of air out of the housing 12. It is understood by those skilled in the art that the air inlet 22 is not limited to being located on the left side surface 24 of the base 12 and that the air outlet 26 is not limited to being located on the top surface 28 of the base 12. For example, the air inlet 22 and air outlet 26 may be located on virtually any surface of the base 12 such that air can flow through the base 12.

Power is preferably supplied to the motor 44 of the air purifier 10 via a power cord 16 that can be connected to a conventional wall outlet (not shown). In the first preferred embodiment, the power cord 16 is operatively connected to the motor 44 and extends out from the base 12 through the air inlet 22 on the left side 24 of the base 12. Thus, the power cord 16 can be extended to connect to a conventional wall outlet by the user. It is understood by those skilled in the art that the present invention is not limited to including a power cord 16 or the above-described location and set-up of the power cord 16. For example, the power cord 16 can be operatively connected to the motor 44 in virtually any configuration, such as extending from the air outlet 26 on the top surface 28 of the base 12 or extending through an opening (not shown) located at a different location on the base 12. Further, the air purifier 10 can be powered by batteries, solar power or other such means.

The base 12 further includes a control dial 18 secured to the front surface 20. The control dial 18 controls the operation of an electrical switch (not shown), such as a rotary switch, which is operatively connected to and in communication with the motor 44. The control dial 18 allows the user to move the switch to control the rate at which the motor 44 operates and thus the rate at which the fan 46 rotates to urge air flow through the base 12. In the first preferred embodiment, the control dial 18 is constructed of a molded, generally rigid polymeric material. However, it is understood by those skilled in the art that the control dial 18 may be constructed of virtually any material that enables a user to functionally control the operation of the motor 44. For example, the control dial 18 may be constructed of a form sheet metal, assembled wooden or machined metal or any other suitable material. Further, it is understood by those skilled in the art that the control dial 18 can be in virtual any form, such as push buttons, remote control and remote control sensor or of switch-like construction.

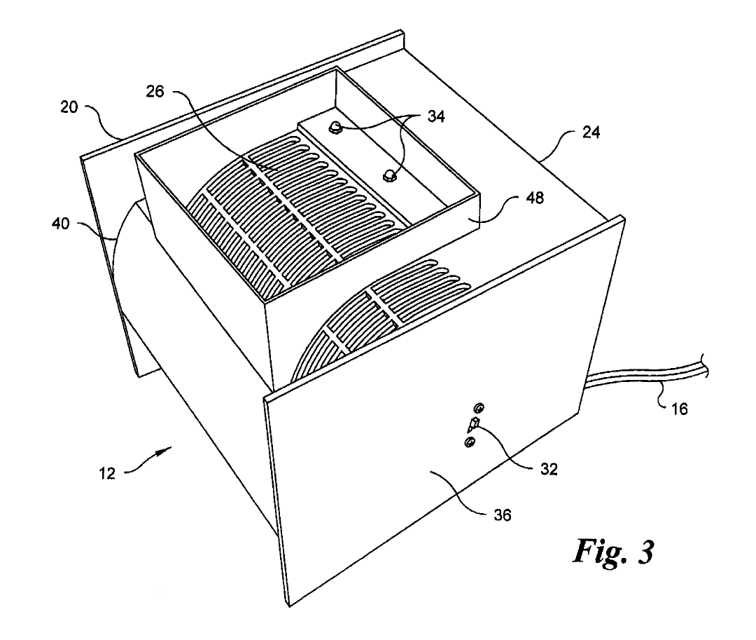

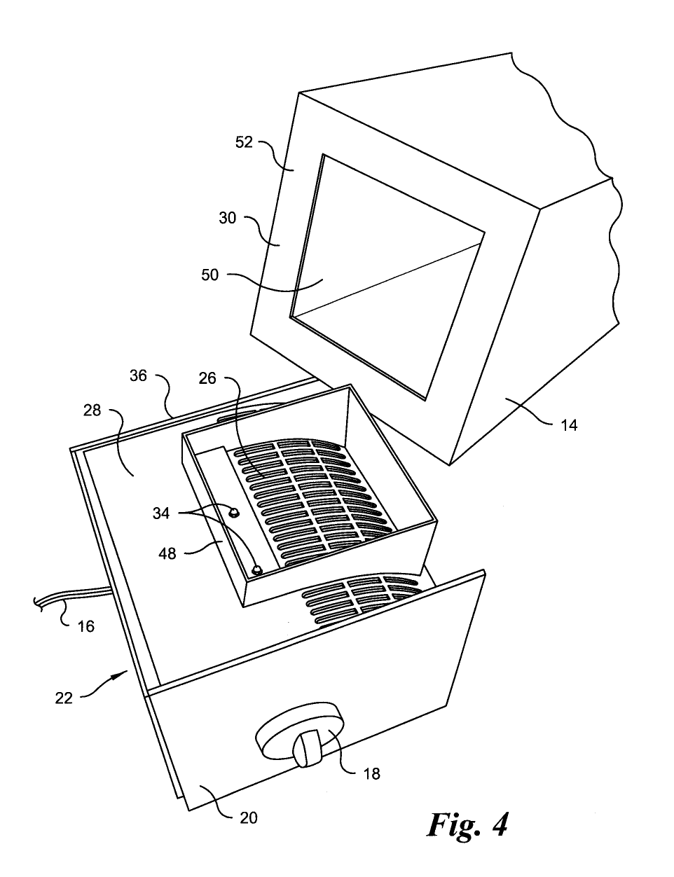

In reference to FIGS. 3 and 4, the base 12 includes a light source comprising at least one light emitting device 34 located on an exterior surface. In the first preferred embodiment, the at least one light emitting device 34 is comprised of two spaced-apart light emitting diodes (LED) located on the top surface 28 of the base 12. Preferably, the at least one light emitting device 34 is located proximate the air outlet 26. Further, a portion of the air outlet 26 and the light emitting device 34 are surrounded by a perimeter wall 48. The perimeter wall 48 is integrally formed with the top surface 28 of the base 12 and extends vertically upwardly from the top surface 28 a predetermined length. It is understood by those skilled in the art that the at least one light emitting device 34 can be comprised of virtually any light emitting device or light source. For example, the at least one light emitting device 34 can be comprised of a gas discharge light, a halogen light, a neon tube, a black-light, a photo luminescent device, an incandescent light or other similar lighting device. Further, the at least one light emitting device 34 can include a plurality of light sources. Furthermore, the at least one emitting device 34 can be located virtually anywhere on the exterior of the base 12 or even on an interior surface of the base 12 that is able to be viewed by the user or consumer.

A slidable light switch 32 is located on the rear surface 36 of the base 12. When power is supplied to the air purifier 10 via the power cord 16, a user can illuminate the at least one light emitting device 34 by switching the light switch 32 into an upper or on position. Further, a user can turn off the at least one light emitting device 34 by switching the light switch 32 into the lower, off position. It is understood by those skilled in the art that the air purifier 10 is not limited to including a light switch 32 or to the above-described light emitting device 34. For example, the light switch 32 can be in the form of a rotary dial, a push button or any other similar structure that can operate the at least one light emitting device 34. One of ordinary skill in the art would understand that the light switch 32 is not limited to being located on the rear surface 36 of the base 12 and can be located on virtually any surface of the base 12. Further, one of ordinary skill in the art would understand that the light switch 32 could be in the form of a motion sensor, such that the at least one light emitting device 34 is illuminated or turned off when the motion sensor detects a particular motion or that the at least one light emitting device 34 may be integral with the motor switch such that the at least one light emitting device 34 illuminates when power is supplied to the motor 44. Alternatively, the light emitting device 34 may be illuminated whenever the air purifier 10 is operating.

Referring to FIGS. 1 and 4-9, the air purifier 10 includes the air filter 14 which is inflatable, foldable and/or collapsible and is in fluid communication with the air outlet 26. Further, the air filter 14 is removably mountable to the air outlet 26 of the base 12 or to an exterior surface of the base 12 proximate the air outlet 26. Specifically, the air filter 14 is removably mountable to the top surface 28 of the base 12 and is preferably secured to the base 12 by fittingly engaging around the exterior surface of the perimeter wall 48. The at least one light emitting device 34 is only directly visible to the user when the air filter 14 is removed from the top surface 28 of the base 12. When the air filter 14 is mounted to the base 12, the air filter 14 encloses the at least one light emitting device 34 and the at least one light emitting device 34 illuminates the interior of the air filter 14 and provides a visual indication when the air filter is becoming old, clogged and/or dirty.

The air filter 14 is preferably constructed of a polypropylene material, but can be made of virtually any air permeable material. For example, the air filter 14 may be constructed of nearly any type or variety of filter material including, but not limited to, a fibrous filter material, a carbon filter or a high efficiency particulate absorbing/high efficiency particle air (HEPA) filter material. The air filter 14 is preferably box-like in shape with rectangular sides and includes an opening 50 on a bottom surface 30. The opening 50 allows a manufacturer or user to access the interior of the air filter 14 for cleaning, repair or other such purposes. To replace or clean the air filter 14 of the air purifier 10, the user must remove the air filter 14 from the top surface 28 of the base 12. The user may either discard the used air filter 14 and replace it with a new air filter 14 or the user may clean the interior surfaces of the air filter 14 and reuse the original air filter 14.

A support 52 is securingly located on the interior of the bottom 30 of the air filter 14. The support 52 provides rigidity to the body 30 of the air filter 14 while also allowing the manufacturer or user to access the interior of the air filter 14. Further, the support 52 located on the bottom 30 of the air filter 14 permits positioning of the air filter 14 onto the perimeter wall 48 on the top surface 28 of the base 12 and aids in the proper alignment of the air filter 14 on the base 12. The support 52 is preferably square in shape with a square central opening and constructed of a material having greater strength or rigidity as compared with the material used to construct the air filter 14. However, it is understood by those skilled in the art that the support 52 can be formed in virtually any shape, such as circular, triangular or donut-shaped, and comprised of virtually any material, such as a metallic or polymeric material.

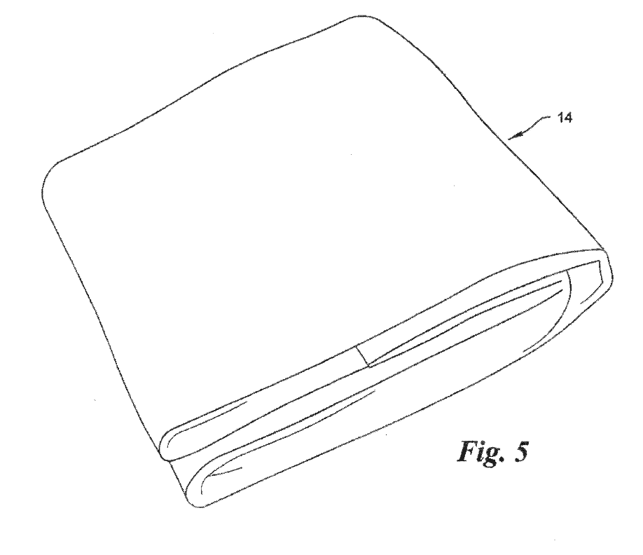

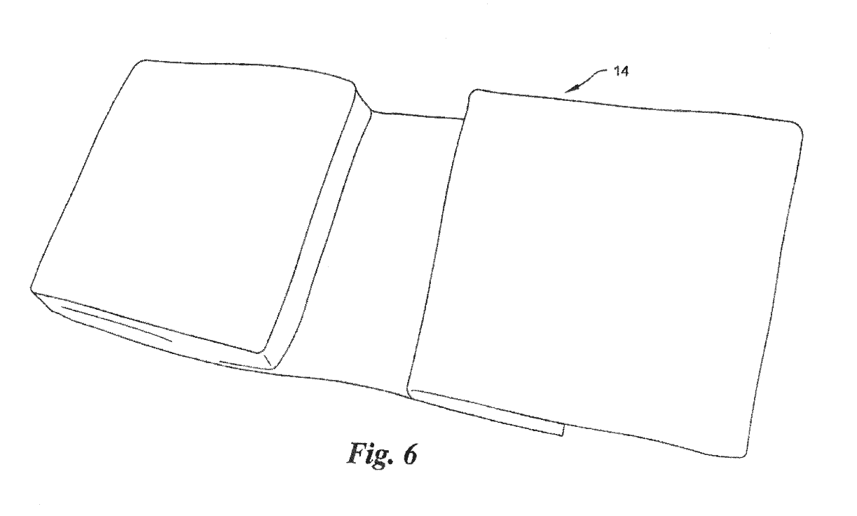

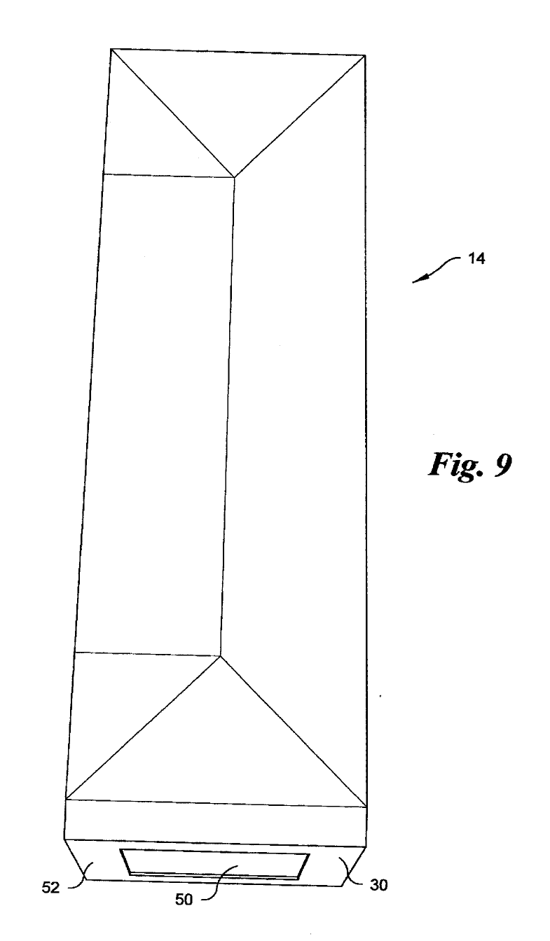

The air filter 14 can be folded to a compact size or configuration for ease of storage and/or shipment (FIG. 5). Further, the air filter 14 can be quickly and conveniently unfolded by a user (FIGS. 6-8) or by the force of the air pressure generated by the fan 46 to a fully expanded position (FIG. 9). In the first preferred embodiment, the air filter 14 is self-standing. However, it is understood by those skilled in the art that the air filter 14 may be constructed to be inflatable, or stand upright to an unfolded position, by the force of the air pressure when the motor 44 of the air purifier 10 is activated and at least partially collapse when the motor 44 is turned off. Further, it is within the spirit and scope of the invention that the air filter 14 be constructed in virtually any size and shape. For example, the air filter 14 can be ovular, circular, triangular or any other shape.

In the first preferred embodiment, the air filter 14 has a known maximum efficiency, or maximum porosity rating, when the air filter 14 is clean and the motor 44 and fan 46 are functioning at their respective maximum operating speeds. For particles having a size in the range of 0.3 to 1.0 microns, the air filter 14 has a minimum efficiency of at least 80% and, more specifically, a filter efficiency of approximately 99.8%. For particles having a size in the range of 1.0 to 3.0 microns, the air filter 14 has a filter efficiency of approximately 99.9%. For particles having a range of 3.0 to 10.0 microns, the air filter 14 has a filter efficiency of approximately 100%. An air filter 14 having the above-described maximum efficiency is designed to trap and collect relatively fine contaminants, dust particles or other similar particles of relatively small size, such as smoke particles or the like.

However, it is understood by those skilled in the art that the present air filter 14 is not limited to having the above-described filter efficiency or porosity rating. It is within the spirit and scope of the invention that the air filter 14 of the air purifier 10 has virtually any filter efficiency that can prevent a particular contaminant, dust particle or other similar particle from continuously circulating in a particular room or environment. For example, to reduce material costs, a manufacturer of the air purifier 10 may decide to use an air filter 14 having a lower minimum efficiency. Further, the user or consumer may only desire to have an air filter 14 that reduces the circulation of larger sized particles, such as pollen, grass or other such allergy particles, from the air. Also, a less efficient air filter 14 does not require the high operating speed of the motor 44 and fan 46 that is required by the maximum efficiency air filter 14 described above. Thus, a less efficient air filter 14 enables the air purifier 10 to operate using less energy and ultimately costs less to operate. At a reduce porosity or minimum efficiency, the air filter 14 would have an approximately 40% filter efficiency for particles having a size in the range of 0.3 to 1.0 microns. For particles have a size in the range of 1.0 to 3.0 microns, the air filter 14 of minimum efficiency would have a filter efficiency of approximately 60%. For particles having a range of 3.0 to 10.0 microns, the air filter 14 of minimum efficiency would have a filter efficiency of approximately 99%.

The air purifier 10 may also include a pre-filter (not shown) located proximate the air inlet 22. The pre-filter serves to reduce the number of large contaminants, dust particles or other such particles from entering the base 12 prior to entering the air filter 14. Preferably, the pre-filter is accessible to the user or consumer and removably mounted proximate to the left side surface 24 of the base 12. However, it is understood by those skilled in the art that pre-filter may be permanently mounted to the exterior of the air inlet 22 on the left side surface 24 of the base 12 or that the pre-filter may be removably or permanently mounted proximate to the interior of the air inlet 22 on the left side surface 24 of the base 12. Preferably, the pre-filter is sized and shaped to conform to the size and shape of the air inlet 22. However, it is understood by those skilled in the art that the size and shape of the pre-filter can be modified. For example, the pre-filter may be larger or smaller than the air inlet 22 and may be circular, rectangular, triangular or other shape.

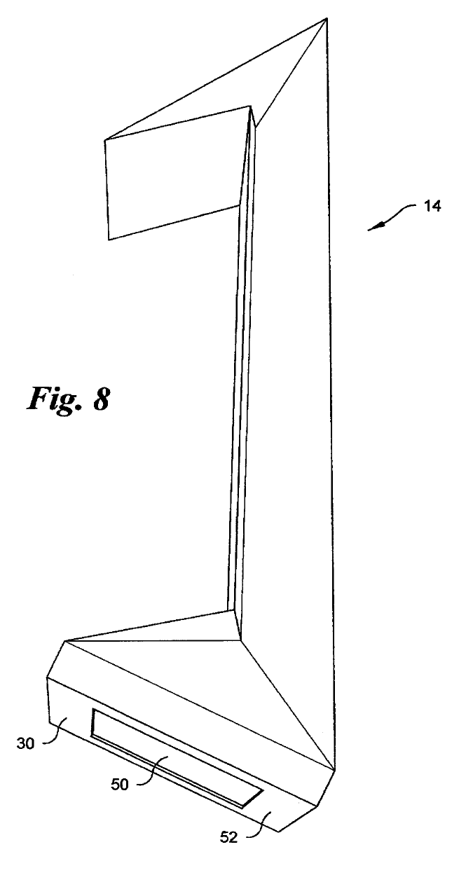

In operation, a user removes the base 12 and folded air filter 14 (FIG. 5) from a box or packaging (not shown) from which the air purifier 10 is stored or transported. The user then plugs the power cord 16 into the wall outlet. Next, the user unfolds the air filter 14 from the fully folded position (FIG. 5) to either the partially expanded position (FIG. 8) or the fully expanded position (FIG. 9). Next, the user attaches the air filter 14 to the base 12 by positioning the opening 50 of the air filter 14 over the perimeter wall 48 on the top surface 28 of the base 12. To assure that the air filter 14 is properly mounted to the base 12, the user makes sure that the support 52, located around the opening 50 of the air filter 14, is in engaging contact with the perimeter wall 48 on the top surface 28 of the base 12. It is understood by those skilled in the art that air purifier 10 may include one or more attaching devices (not shown), such as a clip or a strap, to allow the user to more securely mount the air filter 14 to the base 12.

Next, the user sets the desired speed and functionality of the motor 44 and fan 46 by manipulating the control dial 18. Then the user moves the light switch 32 into the upward and on position to illuminate the at least one light emitting structure 34 located at the top surface 28 of the base 12. In this configuration, air is drawn by the fan 46 through the air inlet 22, through the airflow path and out the air outlet 26. Since the opening 50 of the air filter 14 is securingly engaged to the air outlet 26, the air drawn through the base 12 is expelled into the air filter 14. The efficiency or porosity characteristics of the air filter 14 allow the fine or small air particles to exit the air filter 14 at virtually any location of the air filter 14. However, the air filter 14 prevents larger contaminants, dust particles or other such particles from exiting the air filter 14 and traps the larger contaminants inside the air filter 14.

As understood by one skilled in the art, the at least one light emitting device 34 provides a glowing effect to at least a portion of, and preferably an interior of, the air filter 14 when the air filter 14 is mounted to the base 12. After a certain amount of time has passed and the contaminants, dust particles or other such contaminants that have passed through the base 12 and into the air filter 14 begin to accumulate along the interior walls of the air filter 14, the at least one light emitting device 34 appears to diminish in light intensity to the eye of an observer. This diminishing in light intensity of the at least one light emitting device 34 provides a visual indication to the user that the air filter 14 is becoming clogged with particles or contaminants and that it is time to either clean or replace the air filter 14.

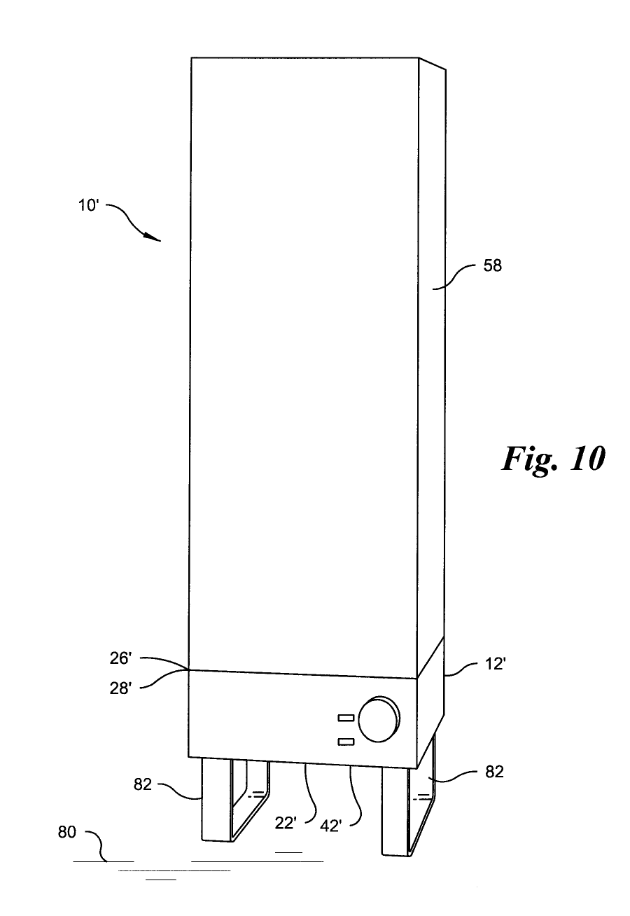

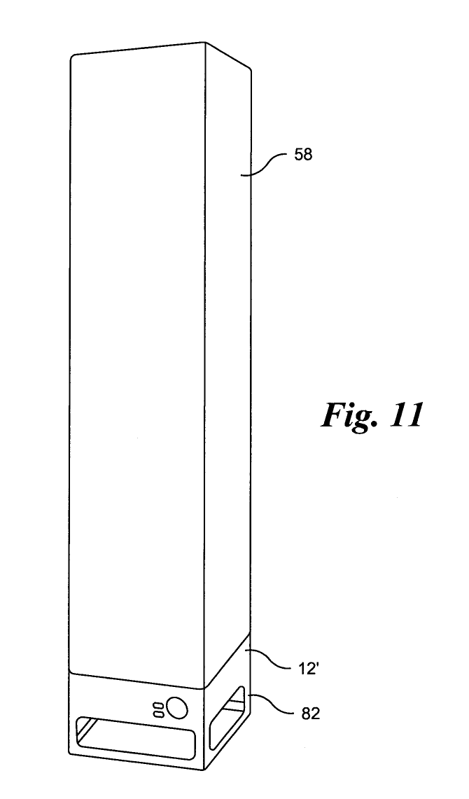

Referring to FIGS. 10-14 a second preferred embodiment of an air purifier 10′ is shown, including like reference numerals to indicate like elements and a prime symbol (′) distinguishing the reference numerals of the second preferred embodiment from the first preferred embodiment. The second preferred embodiment of the air purifier 10′ is substantially similar to the first preferred embodiment to the air purifier 10. As in the air purifier 10 of the first preferred embodiment, the structure of the air purifier 10′ of the second preferred embodiment provides for ease of shipment and storage of the air purifier 10′ and may provide a visual indication to a user when an air filter 14′ becomes old or clogged with dust, particles or other contaminants. In addition, the air purifier 10′ of the second preferred embodiment provides a supporting frame 54 and cover 58 removably mountable to and extending from a base 12′ of the air purifier 10′ for providing an aesthetically pleasing appearance to the air purifier 10′ and for surrounding and supporting the air filter 14′.

Similar to the air purifier 10 of the first preferred embodiment, the air purifier 10′ of the second preferred embodiment includes the foldable, inflatable and/or collapsible air filter 14′ that is removably mountable to an exterior portion of a base 12′ and at least one, and preferably two or more spaced apart, light emitting device (not shown) located on an exterior surface of the base 12′. In addition to the inclusion of the frame 54 that is removably mountable to and extends upwardly from the base 12′, surrounds the air filter 14′ and preferably includes a removably cover 58, the air purifier 10′ of the second preferred embodiment differs from the air purifier 10 of the first preferred embodiment in that the air inlet 22′ of the second preferred embodiment is located on a bottom surface 42′ of the base 12′ and the base 12′ is raised from a supporting surface 80 by at least one, and preferably two or more, spaced apart supporting legs 82.

The base 12′ of the air purifier 10′ of the second preferred embodiment preferably includes an inner housing 62 supported by and positionable within a stand 64. The supporting leg 82 extends from below the stand 64 to provide support for the base 12′ on the supporting surface 80. It is understood by those of ordinary skill in the art that the base 12′ is not limited to the inclusion of supporting legs 82 and may incorporate virtually any other structure that supports the base 12′ on the supporting surface 80. The inner housing 62 encloses a motor (not shown) and an impeller or fan (not shown) for drawing air into the base 12′ and expelling it into the air filter 14′. In the second preferred embodiment, the inner housing 62 and stand 64 may be constructed of a molded, generally rigid polymeric material. The inner housing 62 is generally hollow between the air inlet 22′ and the air outlet 26′ to form the airflow path therethrough. However, the inner housing 62 and stand are not limited to being constructed of generally rigid, molded polymeric material and may be constructed of nearly any material that is able to take on the general shape of the base 12′ and withstanding normal operating conditions of the base 12′. For example, the inner housing 62 and stand 64 of the base 12′ may be constructed of a form sheet metal, assembled wooden or machined metal or any other suitable material.

In the preferred embodiment, the base 12′ is generally box-like in shape with square sides to provide a compact and stable support for the air purifier 10′ and to provide convenient storage and shipment of the air purifier 10′. However, it is understood by those skilled in the art that the form and shape of the base 12′ can be modified. For example, the sides of the base 12′ can be rectangular, triangular or virtually any other shape without departing from the spirit and scope of the invention. It is understood by those skilled in the art that the inner housing 62 may be conveniently removably from the stand 64, through the use of a snap-fit, friction fit or any of a plurality of fasteners (not shown), or example, or the inner housing 62 may be permanently attached to the stand 64.

In the second preferred embodiment, the fan is preferably an axial-type fan or a “squirrel cage” type fan. However, it is understood by those of ordinary skill in the art that the fan may be of virtually any type, shape, or size. For example, the fan my be comprised of a basket-like fan, which is described in U.S. Pat. No. 6,328,791, which is incorporated herein by reference. A control dial 18′ is secured to an outer surface of the stand 64 and allows the user to control the speed at which the motor and fan operate. In addition, push buttons 65 may be located on an exterior surface of the stand to allow the user to control additional features of the air purifier 10′, such as operation of the air filter 14′ and/or a light emitting device (not shown).

In the second preferred embodiment, the air inlet 22′ is located on the bottom surface 42′ of the inner housing 62. As a result, it is important that the inner housing 62 is raised from the supporting surface 80 such that air can be drawn into the air inlet 22′ of the base 12′. Similar to the air outlet 26 of the first preferred embodiment of the air purifier 10, the air outlet 26′ of the second preferred embodiment is located on a top surface of 28′ of the inner housing 62. Further, similar to the first preferred embodiment, the air inlet 22′ and air outlet 26′ of the second preferred embodiment are preferably comprised of slotted vents (not shown) integrally molded into the inner housing 62. However, the air purifier 10′ is not limited to integrally molded vents to form the air inlet 22′ or air outlet 26′, and may be comprised of nearly any penetration, hole, louvered vent or air permeable surface on the base 12′ that permits air flow into and out of the base 12′.

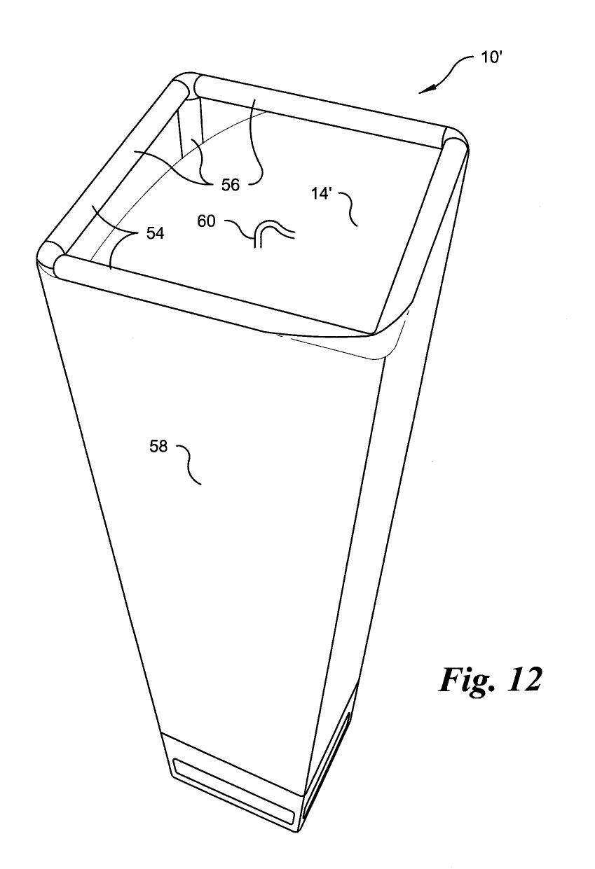

Referring to FIGS. 10-13, the air filter 14′ of the air purifier 10′ of the second preferred embodiment is substantially similar to the air filter 14 of the air purifier 10 of the first preferred embodiment. For example, the air filter 14′ is removable mountable to the air outlet 26′ of the base 12′. The air filter 14′ is inflatable, foldable and/or collapsible and the air filter 14′ is in fluid communication with the air outlet 26′ when mounted to the base 12′. The air purifier 14′ of the second preferred embodiment can be quickly and conveniently unfolded by a user (as shown in FIGS. 6-8) to a fully expanded position (as shown in FIG. 9) and refolded when not in use. Specifically referring to FIG. 12, the air filter 14′ of the second preferred embodiment preferably includes a grasping mechanism 60, such as a loop, of flexible material that extends from a top surface of the air filter 14′. The grasping mechanism 60 provides a handle or grasping mechanism to allow the user to more easily maneuver or manipulate the air filter 14′. It is understood by those skilled in the art that the air purifier 10′ is not limited to the inclusion of the grasping mechanism 60. Further, the grasping mechanism 60 may be modified in sized, shape or location to provide an alternative means to maneuver or manipulate the air filter 14′.

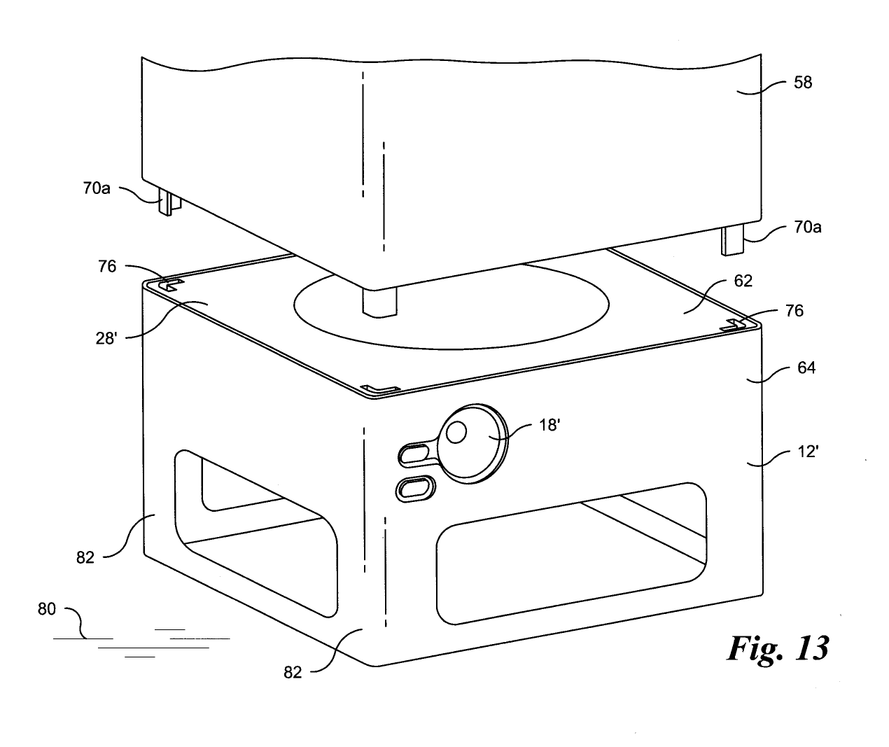

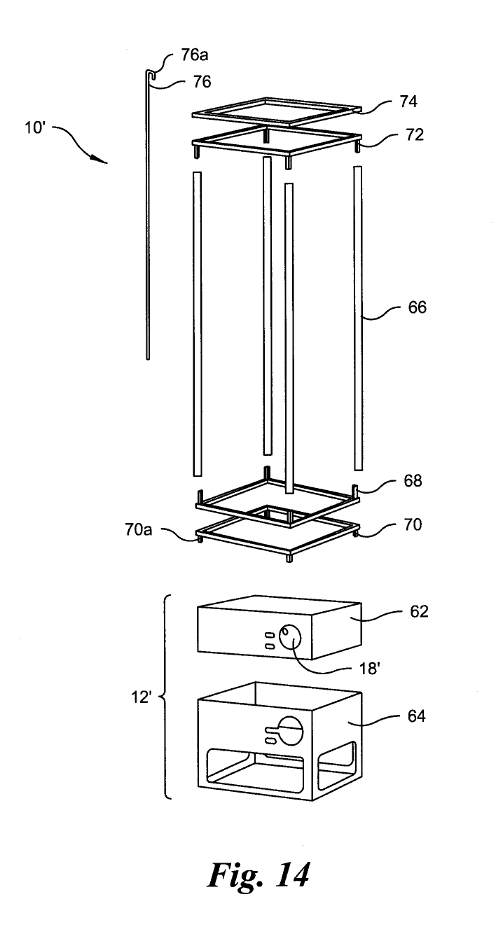

Referring to FIGS. 12-14, the air purifier 10′ of the second preferred embodiment includes the frame 54 that is preferably removably mountable to the perimeter of the top surface 28′ of the base 12′ and the cover 58 that is removably mountable over the outside of the frame 54. As shown in FIG. 14, the frame 54 is comprised of at least two, and preferably a plurality of, interconnected, generally rod-like segments that, when assembled, generally form a hollow box-like shape with generally rectangular sides. Specifically, the frame 54 includes at least two but preferably four frame rods 66, a frame base 68, an frame base cover 70, an upper frame base 72, and a frame top cover 74. As seen in FIG. 13, a plurality of L-shaped protrusions 70a preferably extend from the frame base cover 70 and are removably insertable into corresponding sized and located slots 76 in the top surface 28′ of the base 12′. The protrusions 70a allow the base 12′ to support the assembled frame 54. The frame top cover 74, the upper frame base 72, the frame rod 66, the lower frame base 68 and the frame base cover 70 preferably snap-fit together or are adhesively attached. In the assembled configuration (FIGS. 10-12) the assembled frame 54 extends upwardly above the base 12′ at generally the perimeter of the top surface 28′ of the base 12′. However, it is understood by those of ordinary skill in the art that the frame 54 is not limited to the specific structure described above and may be built or assembled in virtually any manner. For example, the frame 54 may be in the form of a circle, oval or triangular shape when assembled and viewed from above.

Referring to FIG. 14, the air purifier 10′ preferably includes an elongated rod 76 or shaft that is removably located within a portion of the frame 54, and preferably within one of the frame rods 66. The rod 76 may assist the consumer or user in expanding, unfolding and/or inflating the air filter 14′. One end of the rod 76 may include a hook 76a or generally curved surface. In a use configuration in which the rod 76 is removed from one of the frame rods 66, the rod 76 assists a user in engaging the grasping mechanism 60 of the air filter 14′. The rod 76 is preferably sized and shaped to easily and conveniently fit within one of the hollow frame rods 66 in a storage or travel configuration. It is understood by those skilled in the art that the rod 76 is not limited to the specific size and shape described above and that the air purifier 10′ is not limited to the inclusion of the rod 76. For example, the rod 76 may be located in any one of the frame rods 66, frame base 68, frame base cover 70, upper frame base 72 or the frame top cover 74, or any other location that provides a convenient location for storage of the rod 76.

The cover 58, preferably formed of a fabric or cloth material, is removably mounted over and/or around the exterior of the assembled frame 54 to enclose the open sides of the frame 54. As can be seen in FIGS. 13-15, the cover 58 is generally in the form of a sleeve such that it is capable of being slipped over the exterior of the frame 54 in a generally tight, fitting engagement. The readily air pervious or permeable cover 58 is removably mountable around the exterior sides of the frame 54 to provide an aesthetically pleasing appearance to the air purifier 10′ and to provide support to the expended air filter 14′. However, it is understood by those skilled in the art that the size and shape of the cover 58 may be modified. For example, the cover 58 may be in the form of a sack or bag such that the cover 58 encloses the top surfaced of the assembled frame 54 when placed thereon. Further, the cover 58 may include decorative indicia, such as a floral pattern or an advertisement, to improve the aesthetics of the air purifier 10′. Furthermore, the cover 58 may be generally enlarged such that it loosely fits over the assembled frame 54.

In operation, the assembly and usage of the air purifier 10′ of the second preferred embodiment is similar to the air purifier 10 of the first preferred embodiment. Specifically, once the user has mounted the assembled frame 54 onto the base 12′ and placed the cover 58 over and/or around the frame 54, the user may attach the partially folded air filter 14′ onto the air inlet 26′ of the base 12′ or onto an eternal surface of the base 12′. Next, the user connects the power cord 16′ to the conventional power outlet (not shown) and activates the fan and motor by operation of the control knob 18′. Optionally, the user may then remove the rod 76 from within one of the frame rods 66. Next, with the help of the expelled air leaving the air outlet 26′ and entering the partially folded air filter 14′, the user reaches into the area enclosed by the frame 54 and cover 58 and grabs the grasping mechanism 60 on the top surface of the air filter 14′ with either the rod 76 or the user's hand and pulls the top of the air filter 14′ upward to the fully expanded position. Once the air filter 14′ has been fully expanded, the rod 76 can then be placed back within one of the hollow frame rods 66 for storage purposes. The combination of the force exerted by the air from the air outlet 26′ into the air filter 14′ and the pull force of the rod 76 on the grasping mechanism 60 of the air filter 14′ allows the user to quickly and easily unfold and expand the air filter 14′.

It is understood by those skilled in the art that the assembly and usage of the air purifier 10′ is not limited to the specific steps recited above. For instance, the user may attach the partially folded air filter 14′ to at least a portion of the base 12′ before attaching the frame 54 and cover 54 to the base 14′. Alternatively, the user or consumer may expand the air filter 14′ by hand and place the expanded air filter 14′ onto a portion of the base 12′ before or after the frame 54 is attached to the base 12′. Further, the cover 58 may be placed over and/or around the frame 54 after the air filter 14′ is attached to the base 12′.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined by the appended claims.

I/We claim:

1. An air purifier for removing particles or contaminants from air, said air purifier comprising:
a base having an air inlet, an air outlet and an air flow path therethrough;
an impeller for urging air into said air inlet, through said air flow path and out of said air outlet;
a motor for driving said impeller, said motor and impeller supported within said base; and
a foldable air filter in fluid communication with said air outlet and removably mountable to an exterior surface of said base proximate said air outlet.

2. The air purifier of claim 1, wherein said air filter is foldable into a compact configuration for ease of storage and shipment.

3. The air purifier of claim 2, wherein said air filter has a minimum efficiency of at least 80% for particles sized in the range of 0.3 to 1.0 microns.

4. The air purifier of claim 1, wherein said air filter is inflatable to an upright and unfolded position when said motor is activated.

5. The air purifier of claim 4, wherein a grasping mechanism extends from a top surface of said air filter.

6. The air purifier of claim 1, wherein at least one light emitting device is located on an exterior surface of said base.

7. The air purifier of claim 5, wherein said air filter encloses said at least one light emitting device when said air filter is mounted to said base, said at least one light emitting device illuminating at least a portion of said air filter when said air filter is mounted to said base and providing a visual indication when the air filter is becoming clogged.

8. The air purifier of claim 1, further comprising:
a frame removably mountable to said base, wherein the frame surrounds said air filter when said air filter is mounted to said base.

9. The air purifier of claim 8, wherein said frame is comprised of at least two interconnecting segments that generally form a rectangular shape when assembled.

10. The air purifier of claim 8, further comprising:
a cover removably mountable over or around said frame, wherein said cover is air permeable.

11. The air purifier of claim 10, further comprising:
an elongated rod removably located within a portion of said frame to assist a user in unfolding said air filter.

12. An air purifier for removing particles or contaminants from air, comprising:
a base having an air inlet, an air outlet and an air flow path therethrough, said base enclosing a motor for driving an impeller, said base including at least one light emitting device on an exterior surface thereof, and
an air filter removably mountable to an exterior surface of said base,
wherein said air filter encloses said at least one light emitting device when said air filter is mounted to said base, said at least one light emitting device illuminating at least a portion of said air filter when said air filter is mounted to said base and providing a visual indication when the air filter is becoming clogged.

13. The air purifier of claim 12, wherein said air filter is inflatable to an upright and unfolded position when said motor is activated.

14. The air purifier of claim 12, wherein said filter is foldable into a compact configuration for ease of storage and shipment.

15. The air purifier of claim 14, wherein said air filter has a minimum efficiency of at least 80% for particles sized in the range of 0.3 to 1.0 microns.

16. The air purifier of claim 12, wherein said air inlet and air outlet include louvered vents.
